(19) United States
(12) Patent Application Publication
(10) Pub. No.: US 2016/0017110 A1
(43) Pub. Date: Jan. 21, 2016

(54) COMPOSITIONS AND METHODS COMPRISING VINYLIDENE FLUORIDE

(71) Applicant: HONEYWELL INTERNATIONAL INC., Morristown, NJ (US)

(72) Inventors: Rajiv Ratna SINGH, Getzville, NY (US); David J. WILLIAMS, East Amherst, NY (US); Robert RICHARD, Hamburg, NY (US)

(21) Appl. No.: 14/773,555

(22) PCT Filed: Mar. 11, 2014
(86) PCT No.: PCT/US2014/022979

§ 371 Date: Sep. 8, 2015

Related U.S. Application Data
(60) Provisional application No. 61/781,815, filed on Mar. 14, 2013.

(51) Int. Cl. C08J 9/14; C08G 18/76; C08G 18/48; C08G 18/08

(52) U.S. Cl. CPC C08J 9/146; C08G 18/14; C08G 18/7664; C08G 18/4804; C08J 2375/08; C08J 2325/06; C08J 2203/162; C08J 2205/052

(57) ABSTRACT

This invention relates to compositions and methods which make advantageous use of vinylidene fluoride (CH₂═CF₂), and in particular embodiments, to heat transfer fluids and heat transfer methods, blowing agents, and thermoplastic foams which utilize vinylidene fluoride (CH₂═CF₂). Compositions of the present invention include from about 0.1 to about 60 percent, on a weight basis, of a co-agent and from about 99.0 to about 40 percent, on a weight basis, of vinylidene fluoride (CH₂═CF₂).

### CROSS-REFERENCE TO RELATED APPLICATIONS

This application claims the benefit of priority under 35 U.S.C. §119(e) of U.S. Provisional Application Ser. No. 61/781,815, filed on Mar. 14, 2013, the entire disclosure of which is incorporated herein by reference.

### FIELD OF THE INVENTION

This invention relates to compositions and methods which make advantageous use of vinylidene fluoride (CH₂═CF₂), and in particular embodiments to heat transfer fluids and heat transfer methods, blowing agents, and thermoplastic foams which utilize vinylidene fluoride (CH₂═CF₂).

### BACKGROUND

Fluorocarbon based fluids have found widespread use in industry in a number of applications, including as refrigerants, aerosol propellants, blowing agents, heat transfer media, and gaseous dielectrics. Because of the suspected environmental problems associated with the use of some of these fluids, including the relatively high global warming potentials associated therewith, it is desirable to use fluids having low or even zero ozone depletion potential, such as hydrofluorocarbons (“HFCs”). Thus, the use of fluids that do not contain chlorofluorocarbons (“CFCs”) or hydrochlorofluorocarbons (“HCFCs”) is desirable. Furthermore, some HFC fluids may have relatively high global warming potentials associated therewith, and it is desirable to use hydrofluorocarbon or other fluorinated fluids having global warming potentials as low as possible while maintaining the desired performance in use properties. However, the identification of new, environmentally-safe, mixtures is frequently complicated by the need and/or desire to achieve a composition with such a diverse set of properties.

With respect to heat transfer fluids, it is desirable in many different situations to selectively transfer heat between a fluid and a body to be cooled or warmed. As used herein, the term “body” refers not only to solid bodies but also other fluid materials, which take the shape of the container in which they exist.

One well known system for achieving such transfer of heat achieves cooling of a body by first pressurizing a vapor phase heat transfer fluid and then expanding it through a Joule-Thomson expansion element, such as a valve, orifice, or other type of flow constriction. Any such device will be referred to hereinafter simply as a Joule-Thompson expansion element, and systems using such an element are sometimes referred to herein as Joule-Thompson systems. In most Joule-Thomson systems, single component, non-ideal gasses are pressurized and then expanded through a throttling component or expansion element, to produce substantially isenthalpic cooling. The characteristics of the gas used, such as boiling point, inversion temperature, critical temperature, and critical pressure effect the starting pressure needed to reach a desired cooling temperature. While such characteristics are all generally well known and/or relatively easy to predict with an acceptable degree of certainty for single component fluids, this is not necessarily the case for multi-component fluids

Because of the large number of properties or characteristics which are relevant to the effectiveness and desirability of a heat transfer fluid in particular but to many other fluids in general, it is frequently difficult to predict in advance how any particular multi-component fluid will perform as a heat transfer fluid. For example, U.S. Pat. No. 5,774,052—Bivens discloses a combination of difluoroethane (HFC-32), pentafluoroethane (HFC-125) and a small amount (i.e., up to 5% by weight) of carbon dioxide (CO2) in the form of an azeotropic fluid that is said to have advantages as a refrigerant in certain applications. More particularly, the multi-component fluid of Bivens is said to be non-flammable and, due to its azeotropic nature, to undergo relatively little fractionation upon vaporization. However, applicants appreciate that, the fluids of Bivens are comprised of relatively highly-fluorinated compounds, which are potentially environmentally damaging from a global warming perspective. In addition, obtaining fluids with azeotropic properties can sometimes add significantly to the cost of such fluids when used as refrigerants.

U.S. Pat. No. 5,763,063—Richard et al. discloses a non-azeotropic combination of various hydrocarbons, including HFC-32, and carbon dioxide which form a fluid said to be acceptable as replacements for chlorotrans-1,3,3,3-tetrafluoropropene (HCFC-22). In particular, the Richard et al. patent teaches that the vapor pressure of this fluid is substantially equal to HCFC-22, which is only about 83 psia. Therefore, while the fluid of Richard et al. is expected to perform well in certain refrigeration applications, it may be considered inadequate in the same types of applications mentioned above with respect to the Bivens fluid.

### SUMMARY OF THE INVENTION

The present invention relates, in part, to compositions comprising vinylidene fluoride (CH₂═CF₂). In certain preferred embodiments, the present compositions are useful as or in connection with heat transfer fluids, blowing agents, foams, foamable compositions, foam pre-mixes, solvents, cleaning fluids, extractants, flame retardants, fire suppression agents, deposition agents, propellants, sprayable compositions, deposition agents, and to methods and systems relating to each of these.

In connection with the composition aspects of the present invention, the preferred compositions possess a highly desirable yet difficult to obtain combination of properties. The combination of properties possessed by the present compositions is important in many applications, for example, in thermoplastic foam applications, heat transfer applications and other applications as well. The following combination of properties and characteristics is highly desirable and possessed by the preferred embodiments of the present compositions: chemical stability, low toxicity, low- or non-flammability, and efficiency in-use, while at the same time substantially reducing or eliminating the deleterious ozone depletion potential of many of the compositions, such as refrigerants, which have heretofore been commonly used, such as CFCs. In addition, the preferred embodiments of the present invention provide compositions, particularly and preferably in certain embodiments blowing agents, such as in foam (including thermoplastic foam) compositions, heat transfer fluids such as refrigerants, which also substantially reduce or eliminate the negative global warming effects associated with previously used heat transfer fluids. In addition, certain of the preferred heat transfer compositions of the present invention which comprise vinylidene fluoride (CH₂═CF₂) and at least one co-refrigerant provide a relatively high refrigeration capacity and/or coefficient of performance, in addition to the other desirable properties mentioned above. This difficult to achieve combination of properties and/or characteristics is important in many applications, including particularly by way of example, in low temperature air conditioning, refrigeration and heat pump applications.

In one aspect, the present invention provides a composition comprising vinylidene fluoride (CH₂═CF₂) and at least one co-agent. In certain preferred embodiments the present compositions comprise from about 0.1 to about 99 percent, on a weight basis, of vinylidene fluoride (CH₂═CF₂) and from about 0.1 to about 99 percent, on a weight basis, of at least one co-agent. In certain preferred embodiments, the compositions comprise from about 40 to about 99.5 percent, on a weight basis, of vinylidene fluoride (CH₂═CF₂) and from about 0.1 to about 60 percent, on a weight basis, of at least one co-agent. In certain highly preferred embodiments, the at least one co-agent according to the compositions of the present invention comprises at least one co-agent selected from the following group: carbon dioxide (CO₂); tetrafluoropropenes, including 2,3,3,3-tetrafluoropropene (HFO-1234yf) and 1,3,3,3-tetrafluoropropene (HFO-1234ze); C3-C6 hydrocarbons, including preferably C3 and C4 hydrocarbons; hydrofluorocarbons (HFCs), including preferably difluoromethane (HFC-32); difluoroethane (HFC-152a); 1,1,1,2-tetrafluoroethane (HFC-134a); and pentafluoroethane (HFC-125); ammonia; and combinations of any two or more of these.

As used herein, the term “co-agent” is used for the purposes of convenience but not by way of limitation to refer to any compound, other than vinylidene fluoride (CH₂═CF₂), which is present in the composition and which participates in the function of the composition for its intended purpose. In certain preferred embodiments, therefore, the co-agent of the present compositions is a compound, or combination of compounds, which act in the composition as a co-refrigerant, co-blowing agent, co-solvent, co-cleaner, co-deposition agent, co-extractant, co-fire suppressant, co-fire extinguishing agent or co-propellant.

In one aspect, the present invention provides compositions, and preferably heat transfer fluids, comprising vinylidene fluoride (CH₂═CF₂) and at least one co-refrigerant. In certain preferred embodiments the present compositions, particularly heat transfer fluids, comprise from about 40 to about 99.9 percent, on a weight basis, of vinylidene fluoride (CH₂═CF₂) and from about 0.1 to about 60 percent, on a weight basis, of at least one co-refrigerant. In certain highly preferred embodiments, the at least one co-refrigerant according to the compositions and methods of the present invention comprises at least one co-refrigerant selected from the group carbon dioxide (CO₂), 2,3,3,3-tetrafluoropropene (HFO-1234yf), 1,3,3,3-tetrafluoropropene (HFO-1234ze), C3-C6 hydrocarbons, and combinations of any two or more of these.

As with the co-agents of the present compositions in general, it is contemplated that the co-refrigerant of the present invention may include compounds other than and/or in addition to carbon dioxide (CO₂), 2,3,3,3-tetrafluoropropene (HFO-1234yf), 1,3,3,3-tetrafluoropropene (HFO-1234ze), C3-C6 hydrocarbons, and combinations of any two or more of these. In certain preferred embodiments, the co-refrigerant of the present invention consisting essentially of at least one co-refrigerant selected from the group consisting of carbon dioxide (CO₂), 2,3,3,3-tetrafluoropropene (HFO-1234yf), 1,3,3,3-tetrafluoropropene (HFO-1234ze), C3-C6 hydrocarbons, and combinations of any two or more of these.

As used herein, the term “co-refrigerant” used for the purposes of convenience but not by way of limitation to refer to any compound, other than vinylidene fluoride (CH₂═CF₂), which is present in the composition for the purpose of contributing to and/or otherwise participating in the heat transfer characteristics of the composition or for the purpose of being involved in the transfer of heat, and is specifically intended to include such compound(s) which are present when the heat transfer involves heating and/or cooling or refrigeration.

As used herein, the term C3-C6 hydrocarbons is used in its broad sense to include all hydrocarbons, whether branched or unbranched, having at least three and not more than six carbon atoms in a molecule.

In other aspects, the present invention provides compositions, and preferably foam or foamable compositions, comprising vinylidene fluoride (CH₂═CF₂) and at least one co-blowing agent. In certain preferred embodiments the present compositions, particularly blowing agents, foam, or foamable compositions, comprise from about 40 to about 99.9 percent, on a weight basis, of vinylidene fluoride (CH₂═CF₂) and from about 0.1 to about 60 percent, on a weight basis, of at least one co-blowing agent. In certain highly preferred embodiments, the at least one co-blowing agent according to the compositions and methods of the present invention comprises at least one co-blowing agent selected from the group carbon dioxide (CO₂), water, trans-1,2-dichloroethylene, cis or trans 1-chloro-3,3,3-trifluoropropene (HFO-1233zd), 1,1,1,4,4,4-hexafluorobutene (HFO-1336mzzm), trans-1,3,3,3 tetrafluoropropene (HFO-1234ze(E)), C3-C6 hydrocarbons, and combinations of any two or more of these.

As with the co-agents of the present compositions in general, it is contemplated that the co-blowing agent of the present invention may include compounds other than and/or in addition to carbon dioxide (CO₂), 1,3,3,3-tetrafluoropropene (HFO-1234ze), cis or trans 1-chloro-3,3,3-trifluoropropene (HFO-1233zd), 1,1,1,4,4,4-hexafluorobutene (HFO-1336mzzm), C3-C6 hydrocarbons, and combinations of any two or more of these. In certain preferred embodiments, the co-blowing agent of the present invention consisting essentially of at least one co-blowing agent selected from the group consisting of carbon dioxide (CO₂), 1,3,3,3-tetrafluoropropene (HFO-1234ze), cis or trans 1-chloro-3,3,3-trifluoropropene (HFO-1233zd), 1,1,1,4,4,4-hexafluorobutene (HFO-1336mzzm), C3-C6 hydrocarbons, and combinations of any two or more of these.

As used herein, the term “co-blowing agent” used for the purposes of convenience but not by way of limitation to refer to any compound, other than vinylidene fluoride (CH₂═CF₂), which is present in the composition for the purpose of contributing to and/or otherwise participating in the blowing agent characteristics of the composition or for the purpose of being involved in the foam or foamability of a composition.

Additional embodiments and advantages to the present invention will be readily apparent, based on the disclosure provided below.

### BRIEF DESCRIPTION OF THE DRAWING

FIG. 1 shows a diagram of a testing vessel for determining whether a specific blowing agent and polymer are capable of producing a foam.

### DETAILED DESCRIPTION OF PREFERRED EMBODIMENTS

In certain preferred forms, compositions of the present invention have a Global Warming Potential (GWP) of not greater than about 1500, more preferably not greater than about 1000, more preferably not greater than about 500, and even more preferably not greater than about 150. In certain embodiments, the GWP of the present compositions is not greater than about 100, even more preferably not greater than about 75, not greater than 50, not greater than 10, and not greater than 1. As used herein, “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

The amount of the vinylidene fluoride (CH₂═CF₂) contained in the present compositions can vary widely, depending the particular application, and compositions containing more than trace amounts and less than 100% of the compound are within broad the scope of the present invention. In preferred embodiments, the present compositions, particularly blowing agent and heat transfer compositions, comprise vinylidene fluoride (CH₂═CF₂) in amounts from about 0.1% by weight to about 99.9% by weight, and even more preferably from about 5% to about 99.9%. In further embodiments, the present compositions comprise vinylidene fluoride (CH₂═CF₂) in amounts from about 40% by weight to about 100% by weight, or from about 40% by weight to about 99.9% by weight

Many additional compounds or components, including lubricants, stabilizers, metal passivators, corrosion inhibitors, flammability suppressants, and other compounds and/or components that modulate a particular property of the compositions (such as cost for example) may be included in the present compositions, and the presence of all such compounds and components is within the broad scope of the invention. In certain preferred embodiments, the present compositions include, in addition to vinylidene fluoride (CH₂═CF₂), one or more of the following:

Difluoromethane (HFC-32);

Pentafluoroethane (HFC-125);

1,1,1,2-Tetrafluoroethane (HFC-134a);

Difluoroethane (HFC-152a);

1,1,1,2,3,3,3-Heptafluoropropane (HFC-227ea);

1,1,1,3,3,3-hexafluoropropane (HFC-236fa);

1,1,1,3,3-pentafluoropropane (HFC-245fa);

1,1,1,3,3-pentafluorobutane (HFC-365mfc);

water; and

CO₂

The relative amount of any of the above noted compounds of the present invention, as well as any additional components which may be included in present compositions, can vary widely within the general broad scope of the present invention according to the particular application for the composition, and all such relative amounts are considered to be within the scope hereof.

Accordingly, applicants have recognized that certain compositions of the present invention can be used to great advantage in a number of applications. For example, included in the present invention are methods and compositions relating to heat transfer applications, foam and blowing agent applications, propellant applications, sprayable composition applications, aerosol applications, compatibilizer applications, fragrance and flavor applications, inflating agent applications and others. It is believed that those of skill in the art will be readily able to adapt the present compositions for use in any and all such applications without undue experimentation.

The present compositions are generally useful as replacements for CFCs, such as dichlorodifluormethane (CFC-12), HCFCs, such as chlorodifluoromethane (HCFC-22), HFCs, such as tetrafluoroethane (HFC-134a), and combinations of HFCs and CFCs, such as the combination of CFC-12 and 1,1-difluorethane (HFC-152a) (the combination CFC-12:HFC-152a in a 73.8:26.2 mass ratio being known as R-500) in refrigerant, aerosol, and other applications.

The Heat Transfer Fluids

While in certain embodiments the heat transfer fluids of the present invention consist essentially of, vinylidene fluoride (CH₂═CF₂), in many preferred embodiments the present heat transfer fluids comprise vinylidene fluoride (CH₂═CF₂) and one or more co-heat transfer agent, preferably in certain embodiments comprising one or more of halogenated olefins, including HFO-1234yf, HFO-1234ze and combinations thereof, hydrocarbons, hydrofluorocarbons, including HFC-134a and HFC-32, and combinations of these, CO₂, and combinations of any two or more of these.

The heat transfer fluids of the present invention are adaptable for use in a wide variety of heat transfer applications, and all such applications are within the scope of the present invention. The present fluids find particular advantage and unexpectedly beneficial properties in connection with applications that require and/or can benefit from the use of highly efficient, non-flammable refrigerants that exhibit low or negligible global warming effects, and low or no ozone depletion potential. The present fluids also provide advantage to low temperature refrigeration applications, such as those in which the refrigerant is provided at a temperature of about −20° C. or less and which have relatively high cooling power.

In certain embodiments, the preferred heat transfer fluids are highly efficient in that they exhibit a coefficient of performance (COP) that is high relative to the COP of the individual components of the fluid and/or relative to many refrigerants which have previously been used. The term COP is well known to those skilled in the art and is based on the theoretical performance of a refrigerant at specific operating conditions as estimated from the thermodynamic properties of the refrigerant using standard refrigeration cycle analysis techniques. See, for example, “Fluorocarbons Refrigerants Handbook”, Ch. 3, Prentice-Hall, (1988), by R. C. Downing, which is incorporated herein by reference. The coefficient of performance, COP, is a universally accepted measure, especially useful in representing the relative thermodynamic efficiency of a refrigerant in a specific heating or cooling cycle involving evaporation or condensation of refrigerant. COP is related to or a measure of the ratio of useful refrigeration to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. In certain embodiments, the preferred heat transfer fluids exhibit a capacity that is high relative to the capacity of the individual components of the fluid and/or relative to many refrigerants which have previously been used. The cooling capacity of a refrigerant is also an important parameter and can be estimated from certain of the thermodynamic properties of the refrigerant. If the refrigerant is to be used in a system designed for another refrigerant, it is preferred that the capacity of the two refrigerants are similar in order to obtain a similar performance with the same equipment and equipment design. Among the common refrigerants being used in refrigeration and air conditioning/heat pumps, and which may be replaced by the preferred refrigerants of the present invention with a desirable and advantageous match to COP and/or capacity are: R-134a, R-507A, R-404A, R-22, R-407C and R-410A. The applicants have found that various compositions of this invention can be used in the applications where these refrigerants are used with slight adjustments in composition.

As mentioned above, additional components known to those skilled in the art may be added to the mixture to tailor the properties of the heat transfer fluid according to the need.

In connection with evaporative cooling applications, the compositions of the present invention are brought in contact, either directly or indirectly, with a body to be cooled and thereafter permitted to evaporate or boil while in such contact, with the preferred result that the boiling gas in accordance with the present composition absorbs heat from the body to be cooled. In such applications it may be preferred to utilize the compositions of the present invention, preferably in liquid form, by spraying or otherwise applying the liquid to the body to be cooled. In other evaporative cooling applications, it may be preferred to permit a liquid composition in accordance with the present intention to escape from a relatively high pressure container into a relatively lower pressure environment wherein the body to be cooled is in contact, either directly or indirectly, with the container enclosing the liquid composition of the present invention, preferably without recovering or recompressing the escaped gas. One particular application for this type of embodiment is the self cooling of a beverage, food item, novelty item or the like. Previous to the invention described herein, prior compositions, such as HFC-152a and HFC-134a were used for such applications. However, such compositions have recently been looked upon negatively in such application because of the negative environmental impact caused by release of these materials into the atmosphere. For example, the United States EPA has determined that the use of such prior chemicals in this application is unacceptable due to the high global warming nature of these chemicals and the resulting detrimental effect on the environment that may result from their use. The compositions of the present invention should have a distinct advantage in this regard due to their low global warming potential and low ozone depletion potential, as described herein. Additionally, the present compositions are expected to also find substantial utility in connection with the cooling of electrical or electronic components, either during manufacture or during accelerated lifetime testing. In accelerated lifetime testing, the component is sequentially heated and cooled in rapid succession to simulate the use of the component. Such uses would therefore be of particular advantage in the semiconductor and computer board manufacturing industry. Another advantage of the present compositions in this regard is they are expected to exhibit desirable electrical properties when used in connection with such applications. Another evaporative cooling application comprises methods for temporarily causing a discontinuation of the flow of fluid through a conduit. Preferably, such methods would include contacting the conduit, such as a water pipe through which water is flowing, with a liquid composition according to the present invention and allowing the liquid composition of the present invention to evaporate while in contact with the conduit so as to freeze liquid contained therein and thereby temporarily stop the flow of fluid through the conduit. Such methods have distinct advantage in connection with enabling the service or other work to be performed on such conduits, or systems connected to such conduits, at a location downstream of the location at which the present composition is applied.

Although it is contemplated that the compositions of the present invention may include the compounds of the present invention in widely ranging amounts, it is generally preferred that refrigerant compositions of the present invention comprise vinylidene fluoride (CH₂═CF₂) in an amount that is at least about 40% by weight, and even more preferably at least about 60% by weight, of the composition. In certain embodiments, it is preferred that the heat transfer compositions of the present invention comprise vinylidene fluoride (CH₂═CF₂) more preferably between about 40% to about 100% by weight vinylidene fluoride (CH₂═CF₂), more preferably between about 40% to about 99.9% by weight vinylidene fluoride (CH₂═CF₂), and even more preferably between about 60% to about 90% by weight vinylidene fluoride (CH₂═CF₂)

The relative amount of the hydrofluoroolefin used in accordance with the present invention is preferably selected to produce a heat transfer fluid which has the required heat transfer capacity, particularly refrigeration capacity, and preferably is at the same time non-flammable. As used herein, the term non-flammable refers to a fluid which is non-flammable in all proportions in air as measured by ASTM E-681.

The compositions of the present invention may include other components for the purpose of enhancing or providing certain functionality to the composition, or in some cases to reduce the cost of the composition. For example, refrigerant compositions according to the present invention, especially those used in vapor compression systems, include a lubricant, generally in amounts of from about 30 to about 50 percent by weight of the composition. Furthermore, the present compositions may also include a co-refrigerant, or compatibilzer, such as propane, for the purpose of aiding compatibility and/or solubility of the lubricant. Such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include WITCO LP 250® from Witco, ZEROL 300® from Shrieve Chemical, SUNISCO 3GS from Witco, and CALUMET R015 from Calumet. Commercially available alkyl benzene lubricants include ZEROL 150®. Commercially available esters include neopentyl glycol dipelargonate, which is available as EMERY 2917® and HATCOL 2370®. Other useful esters include phosphate esters, dibasic acid esters, and fluoroesters. In some cases, hydrocarbon based oils are have sufficient solubility with the refrigerant that is comprised of an iodocarbon, the combination of the iodocarbon and the hydrocarbon oil might more stable than other types of lubricant. Such combination may therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

In certain preferred embodiments, the heat transfer composition comprises from about 10% to about 95% by weight of vinylidene fluoride (CH₂═CF₂), and from about 5% to about 90% by weight of an adjuvant, particular in certain embodiments a co-refrigerant (such as, but not limited to, CO₂, HFC-32, HFC-125, HFO-1234ze(E) and/or CF₃I). The use of the term co-refrigerant is not intended for use herein in a limiting sense regarding the relative performance of vinylidene fluoride (CH₂═CF₂), but is used instead to identify other components of the refrigerant composition generally that contribute to the desirable heat transfer characteristics of the composition for a desired application. In certain of such embodiments the co-refrigerant comprises, and preferably consists essentially of, one or more HFCs and/or one or more fluoroiodo C1-C3 compounds, such as trifluroiodomethane, and combinations of these with each other and with other components.

In preferred embodiments in which the co-refrigerant comprises HFC, preferably HFC-125, the composition comprises HFC in an amount of from about 50% by weight to about 95% by weight of the total heat transfer composition, more preferably from about 60% by weight to about 90% by weight, and even more preferably of from about 70% to about 90% by weight of the composition. In other embodiments the compound of the present invention preferably comprises, and even more preferably consists essentially of vinylidene fluoride (CH₂═CF₂) in an amount of from about 10% by weight to about 100% by weight of the total heat transfer composition, more preferably from about 40% by weight to about 100% by weight, and even more preferably of from about 40% to about 90% by weight of the composition.

Heat Transfer Methods and Systems

The method aspects of the present invention comprise transferring heat to or from a body using a heat transfer fluid in accordance with the present invention. Those skilled in the art will appreciate that many known methods may be adapted for use with the present invention in view of the teachings contained herein, and all such methods are within the broad scope hereof. For example, vapor compressions cycles are methods commonly used for refrigeration and/or air conditioning. In its simplest form, the vapor compression cycle involves providing the present heat transfer fluid in liquid form and changing the refrigerant from the liquid to the vapor phase through heat absorption, generally at relatively low pressure, and then from the vapor to the liquid phase through heat removal, generally at an elevated pressure. In such embodiments, the refrigerant of the present invention is vaporized in one or more vessels, such as an evaporator, which is in contact, directly or indirectly, with the body to be cooled. The pressure in the evaporator is such that vaporization of the heat transfer fluid takes place at a temperature below the temperature of the body to be cooled. Thus, heat flows from the body to the refrigerant and causes the refrigerant to vaporize. The heat transfer fluid in vapor form is then removed, preferably by means of a compressor or the like which at once maintains a relatively low pressure in the evaporator and compresses the vapor to a relatively high pressure. The temperature of the vapor is also generally increased as a result of the addition of mechanical energy by the compressor. The high pressure vapor then passes to one or more vessels, preferably a condenser, whereupon heat exchange with a lower temperature medium removes the sensible and latent heats, producing subsequent condensation. The liquid refrigerant, optionally with further cooling, then passes to the expansion valve and is ready to cycle again.

In one embodiment, the present invention provides a method for transferring heat from a body to be cooled to the present heat transfer fluid comprising compressing the fluid in a centrifugal chiller, which may be single or multi-stage. As used herein, the term “centrifugal chiller” refers to one or more pieces of equipment which cause an increase in the pressure of the present heat transfer fluid.

The present methods also provide transferring energy from the heat transfer fluid to a body to be heated, for example, as occurs in a heat pump, which may be used to add energy to the body at a higher temperature. Heat pumps are considered reverse cycle systems because for heating, the operation of the condenser is generally interchanged with that of the refrigeration evaporator.

The present invention also provides methods, systems and apparatus for cooling of objects or very small portions of objects to very low temperatures, sometimes referred to herein for the purposes of convenience, but not by way of limitation, as micro-freezing. The objects to be cooled in accordance with the present micro-freezing methods may include biological matter, electronic components, and the like. In certain embodiments, the invention provides for selective cooling of a very small or even microscopic object to a very low temperature without substantially affecting the temperature of surrounding objects. Such methods, which are sometimes referred to herein as “selective micro-freezing,” are advantageous in several fields, such as for example in electronics, where it may be desirable to apply cooling to a miniature component on a circuit board without substantially cooling adjacent components. Such methods may also provide advantage in the field of medicine, where it may be desirable cool miniature discrete portions of biological tissue to very low temperatures in the performance of cryosurgery, without substantially cooling adjacent tissues.

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like. In certain preferred embodiments, the compositions of the present invention are used in refrigeration systems originally designed for use with an HFC refrigerant, such as, for example, R-508B (a blend of HFC-23 and FC-116). The preferred compositions of the present invention tend to exhibit many of the desirable characteristics of R-508B and other HFC refrigerants, including a GWP that is as low, or lower than that of conventional HFC refrigerants and a capacity that is as high or higher than such refrigerants and a capacity that is substantially similar to or substantially matches, and preferably is as high as or higher than such refrigerants. In particular, applicants have recognized that certain preferred embodiments of the present compositions tend to exhibit relatively low global warming potentials (“GWPs”), preferably less than about 1000, more preferably less than about 500, and even more preferably less than about 150. In certain embodiments, the GWP of the present compositions is not greater than about 100, even more preferably not greater than about 75, not greater than 50, not greater than 10, and not greater than 1. In addition, the relatively constant boiling nature of certain of the present compositions makes them even more desirable than certain conventional HFCs, such as R-404A or combinations of HFC-32, HFC-125 and HFC-134a (the combination HFC-32:HFC-125:HFC134a in approximate 23:25:52 weight ratio is referred to as R-407C), for use as refrigerants in many applications.

In certain other preferred embodiments, the present compositions are used in refrigeration systems originally designed for use with a CFC-refrigerant. Preferred refrigeration compositions of the present invention may be used in refrigeration systems containing a lubricant used conventionally with CFC-refrigerants, such as mineral oils, polyalkylbenzene, polyalkylene glycol oils, and the like, or may be used with other lubricants traditionally used with HFC refrigerants. As used herein the term “refrigeration system” refers generally to any system or apparatus; or any part or portion of such a system or apparatus, which employs a refrigerant to provide cooling. Such refrigeration systems include, for example, air conditioners, electric refrigerators, chillers (including chillers using centrifugal compressors), transport refrigeration systems, commercial refrigeration systems and the like.

Many existing refrigeration systems are currently adapted for use in connection with existing refrigerants, and the compositions of the present invention are believed to be adaptable for use in many of such systems, either with or without system modification. Many applications the compositions of the present invention may provide an advantage as a replacement in smaller systems currently based on certain refrigerants, for example those requiring a small refrigerating capacity and thereby dictating a need for relatively small compressor displacements. Furthermore, in embodiments where it is desired to use a lower capacity refrigerant composition of the present invention, for reasons of efficiency for example, to replace a refrigerant of higher capacity, such embodiments of the present compositions provide a potential advantage. Thus, it is preferred in certain embodiments to use compositions of the present invention, particularly compositions comprising a substantial proportion of, and in some embodiments consisting essentially of the present compositions, as a replacement for existing refrigerants, such as: HFC-134a; CFC-12; HCFC-22; HFC-152a; combinations of pentfluoroethane (HFC-125), trifluorethane (HFC-143a) and tetrafluoroethane (HFC-134a) (the combination HFC-125:HFC-143a:HFC134a in approximate 44:52:4 weight ratio is referred to as R-404A); combinations of HFC-32, HFC-125 and HFC-134a (the combination HFC-32:HFC-125:HFC134a in approximate 23:25:52 weight ratio is referred to as R-407C); combinations of methylene fluoride (HFC-32) and pentfluoroethane (HFC-125) (the combination HFC-32:HFC-125 in approximate 50:50 weight ratio is referred to as R-410A); and combinations of HFC-125 and HFC-143a (the combination HFC-125:HFC143a in approximate 50:50 weight ratio is referred to as R-507A). In certain embodiments it may also be beneficial to use the present compositions in connection with the replacement of refrigerants formed from the combination HFC-32:HFC-125:HFC134a in approximate 20:40:40 weight ratio, which is referred to as R-407A, or in approximate 15:15:70 weight ratio, which is referred to as R-407D. The present compositions are also believed to be suitable as replacements for the above noted compositions in other applications, such as aerosols, blowing agents and the like, as explained elsewhere herein.

In certain applications, the refrigerants of the present invention potentially permit the beneficial use of larger displacement compressors, thereby resulting in better energy efficiency than other refrigerants, such as R-508B. Therefore the refrigerant compositions of the present invention provide the possibility of achieving a competitive advantage on an energy basis for refrigerant replacement applications, including automotive air conditioning systems and devices, commercial refrigeration systems and devices, chillers, residential refrigerator and freezers, general air conditioning systems, heat pumps and the like.

Many existing refrigeration systems are currently adapted for use in connection with existing refrigerants, and the compositions of the present invention are believed to be adaptable for use in many of such systems, either with or without system modification. In many applications the compositions of the present invention may provide an advantage as a replacement in systems which are currently based on refrigerants having a relatively high capacity. Furthermore, in embodiments where it is desired to use a lower capacity refrigerant composition of the present invention, for reasons of cost for example, to replace a refrigerant of higher capacity, such embodiments of the present compositions provide a potential advantage. Thus, it is preferred in certain embodiments to use compositions of the present invention, particularly compositions comprising a substantial proportion of, and in some embodiments consisting essentially of vinylidene fluoride (CH₂═CF₂) as a replacement for existing refrigerants, such as R-508B. In certain applications, the refrigerants of the present invention potentially permit the beneficial use of larger displacement compressors, thereby resulting in better energy efficiency than other refrigerants, such as HFC-134a. Therefore the refrigerant compositions of the present invention provide the possibility of achieving a competitive advantage on an energy basis for refrigerant replacement applications.

It is contemplated that the compositions of the present invention also have an advantage (either in original systems or when used as a replacement for refrigerants typically used in connection with low temperature cascade systems. In certain of such embodiments it is preferred to include in the present compositions from about 0.5 to about 30% of a supplemental flammability suppressant, and in certain cases more preferably 0.5% to about 15% by weight and even more preferably from about 0.5 to about 10% on a weight basis

In another embodiment, the compositions of this invention may be used as propellants in sprayable compositions, either alone or in combination with known propellants. The propellant composition comprises, more preferably consists essentially of, and, even more preferably, consists of the compositions of the invention. The active ingredient to be sprayed together with inert ingredients, solvents, and other materials may also be present in the sprayable mixture. Preferably, the sprayable composition is an aerosol. Suitable active materials to be sprayed include, without limitation, cosmetic materials such as deodorants, perfumes, hair sprays, cleansers, and polishing agents as well as medicinal materials such as anti-asthma and anti-halitosis medications.

### Blowing Agents, Foams and Foamable Compositions

Blowing agents may also comprise or constitute one or more of the present compositions. As mentioned above, the compositions of the present invention may include the compounds of the present invention in widely ranging amounts. It is generally preferred, however, that for preferred compositions for use as blowing agents in accordance with the present invention, vinylidene fluoride (CH₂═CF₂) are present in an amount that is at least about 0.1% by weight, and even more preferably at least about 15% by weight, of the composition. In certain preferred embodiments, the blowing agent comprises at least about 40% by weight of the present compositions, and in certain embodiments the blowing agent consists essentially of the present compositions.

Although it is contemplated that the compositions of the present invention may include the compounds of the present invention in widely ranging amounts, it is generally preferred that blowing agent compositions of the present invention comprise vinylidene fluoride (CH₂═CF₂) in an amount that is at least about 40% by weight, and even more preferably at least about 60% by weight, of the composition. In certain embodiments, it is preferred that the blowing agent compositions of the present invention comprise vinylidene fluoride (CH₂═CF₂) more preferably between about 40% to about 100% by weight vinylidene fluoride (CH₂═CF₂), more preferably between about 40% to about 99.9% by weight vinylidene fluoride (CH₂═CF₂), and even more preferably between about 60% to about 95% by weight vinylidene fluoride (CH₂═CF₂)

In certain preferred embodiments, the blowing agent compositions of the present invention and include, in addition to vinylidene fluoride (CH₂═CF₂), one or more of co-blowing agents, fillers, vapor pressure modifiers, flame suppressants or retardants, colorants stabilizers and like adjuvants. The co-blowing agent in accordance with the present invention can comprise a physical blowing agent, a chemical blowing agent (which preferably in certain embodiments comprises water) or a blowing agent having a combination of physical and chemical blowing agent properties. It will also be appreciated that the blowing agents included in the present compositions, including vinylidene fluoride (CH₂═CF₂) as well as the co-blowing agent, may exhibit properties in addition to those required to be characterized as a blowing agent. For example, it is contemplated that the blowing agent compositions of the present invention may include components, including vinylidene fluoride (CH₂═CF₂), which also impart some beneficial property to the blowing agent composition or to the foamable composition to which it is added. For example, it is within the scope of the present invention for vinylidene fluoride (CH₂═CF₂) or for the co-blowing agent to also act as a polymer modifier or as a viscosity reduction modifier.

By way of example, one or more of the following components may be included in certain preferred blowing agents of the present invention in widely varying amounts: hydrocarbons, hydrofluorocarbons (HFCs), ethers, alcohols, aldehydes, ketones, methyl formate, formic acid, water, trans-1,2-dichloroethylene, cis or trans 1-chloro-3,3,3-trifluoropropene (HFO-1233zd), 1,1,1,4,4,4-hexafluorobutene (HFO-1336mzzm), cis or trans 1,3,3,3-tetrafluoropropene, carbon dioxide and combinations of any two or more of these. Among ethers, it is preferred in certain embodiments to use ethers having from two to six carbon atoms. Among alcohols, it is preferred in certain embodiments to use alcohols having from one to four carbon atoms. Among aldehydes, it is preferred in certain embodiments to use aldehydes having from one to four carbon atoms.

In other embodiments, the invention provides foamable compositions. The foamable compositions of the present invention generally include one or more components capable of forming foam having a generally cellular structure and a blowing agent in accordance with the present invention. In certain embodiments, the one or more components comprise a thermosetting composition capable of forming foam and/or foamable compositions. Examples of thermosetting compositions include polyurethane and polyisocyanurate foam compositions, and also phenolic foam compositions. In such foam embodiments, one or more of the present compositions are included as a blowing agent in a foamable composition, which composition preferably includes one or more additional components capable of reacting and foaming, or as part of a premix containing one or more parts of the foamable composition, which preferably includes one or more of the components capable of reacting and/or foaming under the proper conditions to form a foam or cellular structure, as is well known in the art.

With respect to foam types, particularly polyurethane foam compositions, the present invention provides rigid foam (both closed cell, open cell and any combination thereof), flexible foam, and semiflexible foam, including integral skin foams. The present invention provides also single component foams, which include sprayable single component foams.

The reaction and foaming process may be enhanced through the use of various additives such as catalysts and surfactant materials that serve to control and adjust cell size and to stabilize the foam structure during formation. Furthermore, it is contemplated that any one or more of the additional components described above with respect to the blowing agent compositions of the present invention could be incorporated into the foamable composition of the present invention. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure.

In certain aspects, the surfactant may include a silicone surfactant. The silicone surfactant is preferably used to emulsify the polyol preblend mixture, as well as to control the size of the bubbles of the foam so that a foam of a desired cell structure is obtained. Preferably, a foam with small bubbles or cells therein of uniform size is desired since it has the most desirable physical properties such as compressive strength and thermal conductivity. Also, it is critical to have a foam with stable cells which do not collapse prior to forming or during foam rise.

Silicone surfactants for use in the preparation of polyurethane or polyisocyanurate foams are available under a number of trade names known to those skilled in this art. Such materials have been found to be applicable over a wide range of formulations allowing uniform cell formation and maximum gas entrapment to achieve very low density foam structures. The preferred silicone surfactant comprises a polysiloxane polyoxyalkylene block co-polymer. Some representative silicone surfactants useful for this invention are Momentive's L-5130, L-5180, L-5340, L-5440, L-6100, L-6900, L-6980 and L-6988; Air Products DC-193, DC-197, DC-5582, DC-5357 and DC-5598; and B-8404, B-8407, B-8409 and B-8462 from Evonik Industries AG of Essen, Germany. Others are disclosed in U.S. Pat. Nos. 2,834,748; 2,917,480; 2,846,458 and 4,147,847. The silicone surfactant component is usually present in the polyol premix composition in an amount of from about 0.5 wt. % to about 5.0 wt. %, preferably from about 1.0 wt. % to about 4.0 wt. %, and more preferably from about 1.5 wt. % to about 3.0 wt. %, by weight of the polyol premix composition.

Surfactants may also include, however, non-silicone surfactants, such as a non-silicone, non-ionic surfactant. Such may include oxyethylated alkylphenols, oxyethylated fatty alcohols, paraffin oils, castor oil esters, ricinoleic acid esters, turkey red oil, groundnut oil, paraffins, and fatty alcohols. The preferred non-silicone non-ionic surfactants are Dabco LK-221 or LK-443 which is commercially available from Air Products Corporation, and VORASURF™ 504 from DOW. When a non-silicone, non-ionic surfactant used, it is usually present in the polyol premix composition in an amount of from about 0.25 wt. % to about 3.0 wt. %, preferably from about 0.5 wt. % to about 2.5 wt. %, more preferably from about 0.75 wt. % to about 2.5 wt. %, and even more preferably from about 0.75 wt. % to about 2.0 wt. %, by weight of the polyol premix composition.

The inventive polyol premix composition preferably contains a catalyst or a catalyst system. In certain aspects, the catalyst system includes an amine catalyst. The amine catalyst may include any one or more compounds containing an amino group and exhibiting the catalytic activity provided herein. Such compounds may be straight chain or cyclic non-aromatic or aromatic in nature. Useful, in certain aspects of the present invention, are primary amine, secondary amine or tertiary amine catalysts. Useful tertiary amine catalysts non-exclusively include N,N,N′,N″,N″-pentamethyldiethyltriamine (Polycat 5—Air Products and Chemicals, Inc.), N,N-dicyclohexylmethylamine; N,N-ethyldiisopropylamine; N,N-dimethylcyclohexylamine; N,N-dimethylisopropylamine; N-methyl-N-isopropylbenzylamine; N-methyl-N-cyclopentylbenzylamine; N-isopropyl-N-sec-butyl-trifluoroethylamine; N,N-diethyl-(α-phenylethyl)amine, N,N,N-tri-n-propylamine, or combinations thereof. Useful secondary amine catalysts non-exclusively include dicyclohexylamine; t-butylisopropylamine; di-t-butylamine; cyclohexyl-t-butylamine; di-sec-butylamine, dicyclopentylamine; di-(α-trifluoromethylethyl)amine; di-(α-phenylethyl)amine; or combinations thereof. Useful primary amine catalysts non-exclusively include: triphenylmethylamine and 1,1-diethyl-n-propylamine.

Other useful amines includes morpholines, imidazoles, ether containing compounds, and the like. These include

dimorpholinodiethylether

### N-ethylmorpholine

### N-methylmorpholine

bis(dimethylaminoethyl) ether
imidizole
n-methylimidazole
1,2-dimethylimidazole
dimorpholinodimethylether
N,N,N′,N′,N″,N″-pentamethyldiethylenetriamine
N,N,N′,N′,N″,N″-pentaethyldiethylenetriamine
N,N,N′,N′,N″,N″-pentamethyldipropylenetriamine
bis(diethylaminoethyl) ether
bis(dimethylaminopropyl) ether.

In certain preferred embodiments the amine catalyst(s) are present in the polyol premix composition in an amount of from about 0.001 wt. % to about 5.0 wt. %, 0.01 wt. % to about 3.0 wt. %, preferably from about 0.3 wt. % to about 2.5 wt. %, and more preferably from about 0.35 wt. % to about 2.0 wt. %, by weight of the polyol premix composition. While these are usual amounts, the quantity amount of the foregoing catalyst can vary widely, and the appropriate amount can be easily be determined by those skilled in the art.

In addition to (or in certain embodiments in place of) an amine catalyst, the catalyst system of the present invention also includes at least one non-amine catalyst. In certain embodiments, the non-amine catalysts are inorgano- or organo-metallic compounds. Useful inorgano- or organo-metallic compounds include, but are not limited to, organic salts, Lewis acid halides, or the like, of any metal, including, but not limited to, transition metals, post-transition (poor) metals, rare earth metals (e.g. lanthanides), metalloids, alkali metals, alkaline earth metals, or the like. According to certain broad aspects of the present invention, the metals may include, but are not limited to, bismuth, lead, tin, zinc, chromium, cobalt, copper, iron, manganese, magnesium, potassium, sodium, titanium, mercury, zinc, antimony, uranium, cadmium, thorium, aluminum, nickel, cerium, molybdenum, vanadium, zirconium, or combinations thereof. Non-exclusive examples of such inorgano- or organo-metallic catalysts include, but are not limited to, bismuth nitrate, lead 2-ethylhexoate, lead benzoate, lead naphthanate, ferric chloride, antimony trichloride, antimony glycolate, tin salts of carboxylic acids, dialkyl tin salts of carboxylic acids, potassium acetate, potassium octoate, potassium 2-ethylhexoate, potassium salts of carboxylic acids, zinc salts of carboxylic acids, zinc 2-ethylhexanoate, glycine salts, alkali metal carboxylic acid salts, sodium N-(2-hydroxy-5-nonylphenol)methyl-N-methylglycinate, tin (II) 2-ethylhexanoate, dibutyltin dilaurate, or combinations thereof. In certain preferred embodiments the catalysts are present in the polyol premix composition in an amount of from about 0.001 wt. % to about 5.0 wt. %, 0.01 wt. % to about 3.0 wt. %, preferably from about 0.3 wt. % to about 2.5 wt. %, and more preferably from about 0.35 wt. % to about 2.0 wt. %, by weight of the polyol premix composition. While these are usual amounts, the quantity amount of the foregoing catalyst can vary widely, and the appropriate amount can be easily be determined by those skilled in the art.

In another embodiment of the invention, the non-amine catalyst is a quaternary ammonium carboxylate. Useful quaternary ammonium carboxylates include, but are not limited to: (2-hydroxypropyl)trimethylammonium 2-ethylhexanoate (TMR® sold by Air Products and Chemicals) and (2-hydroxypropyl)trimethylammonium formate (TMR-2® sold by Air Products and Chemicals). These quaternary ammonium carboxylate catalysts are usually present in the polyol premix composition in an amount of from about 0.25 wt. % to about 3.0 wt. %, preferably from about 0.3 wt. % to about 2.5 wt. %, and more preferably from about 0.35 wt. % to about 2.0 wt. %, by weight of the polyol premix composition. While these are usual amounts, the quantity amount of catalyst can vary widely, and the appropriate amount can be easily be determined by those skilled in the art.

In certain other embodiments, the one or more components comprise thermoplastic materials, particularly thermoplastic polymers and/or resins. Examples of thermoplastic foam components include polyolefins, such as for example monovinyl aromatic compounds of the formula Ar—CHCH₂ wherein Ar is an aromatic hydrocarbon radical of the benzene series such as polystyrene (PS),(PS). Other examples of suitable polyolefin resins in accordance with the invention include the various ethylene resins including the ethylene homopolymers such as polyethylene (PE), and ethylene copolymers, polypropylene (PP) and polyethyleneterepthalate (PET), and foams formed there from, preferably low-density foams. In certain embodiments, the thermoplastic foamable composition is an extrudable composition.

The invention also relates to foam, and preferably closed cell foam, prepared from a polymer foam formulation containing a blowing agent comprising the compositions of the invention. In yet other embodiments, the invention provides foamable compositions comprising thermoplastic or polyolefin foams, such as polystyrene (PS), polyethylene (PE), polypropylene (PP) and polyethyleneterpthalate (PET) foams, preferably low-density foams. Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention.

It is convenient in many applications to provide the components for polyurethane or polyisocyanurate foams in pre-blended formulations. Most typically, the foam formulation is pre-blended into two components. The isocyanate and optionally other isocyanate compatible raw materials, including but not limited to blowing agents and certain surfactants, comprise the first component, commonly referred to as the “A” component. The polyol mixture composition, including surfactant, catalysts, blowing agents, and optional other ingredients comprise the second component, commonly referred to as the “B” component. In any given application, the “B” component may not contain all the above listed components, for example some formulations omit the flame retardant if flame retardancy is not a required foam property. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all, with the exception of water, incorporated into one B component as described above.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372. Preferred as a class are the aromatic polyisocyanates.

Representative organic polyisocyanates correspond to the formula:

R(NCO)_{z}

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are employed in amounts which will yield an NCO/OH stoichiometric ratio in a range of from about 0.9 to about 5.0. In the present invention, the NCO/OH equivalent ratio is, preferably, about 1.0 or more and about 3.0 or less, with the ideal range being from about 1.1 to about 2.5. Especially suitable organic polyisocyanate include polymethylene polyphenyl isocyanate, methylenebis(phenyl isocyanate), toluene diisocyanates, or combinations thereof.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred species within the classes are potassium acetate, potassium octoate, and N-(2-hydroxy-5-nonylphenol)methyl-N-methylglycinate.

Conventional flame retardants can also be incorporated, preferably in amount of not more than about 20 percent by weight of the reactants. Optional flame retardants include tris(2-chloroethyl)phosphate, tris(2-chloropropyl)phosphate, tris(2,3-dibromopropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl)aminomethyiphosphonate, dimethyl methylphosphonate, tri(2,3-dibromopropyl)phosphate, tri(1,3-dichloropropyl)phosphate, and tetra-kis-(2-chloroethyl)ethylene diphosphate, triethylphosphate, diammonium phosphate, various halogenated aromatic compounds, antimony oxide, aluminum trihydrate, polyvinyl chloride, melamine, and the like. Other optional ingredients can include from 0 to about 7 percent water, which chemically reacts with the isocyanate to produce carbon dioxide. This carbon dioxide acts as an auxiliary blowing agent. In the case of this invention, the water cannot be added to the polyol blend but, if used, can be added as a separate chemical stream. Formic acid is also used to produce carbon dioxide by reacting with the isocyanate and is optionally added to the “B” component.

In addition to the previously described ingredients, other ingredients such as, dyes, fillers, pigments and the like can be included in the preparation of the foams. Dispersing agents and cell stabilizers can be incorporated into the present blends. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from about 5 parts to 100 parts per 100 parts of polyol. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

The polyurethane or polyisocyanurate foams produced can vary in density from about 0.5 pounds per cubic foot to about 60 pounds per cubic foot, preferably from about 1.0 to 20.0 pounds per cubic foot, and most preferably from about 1.5 to 6.0 pounds per cubic foot. The density obtained is a function of how much of the blowing agent or blowing agent mixture disclosed in this invention plus the amount of auxiliary blowing agent, such as water or other co-blowing agents is present in the A and/or B components, or alternatively added at the time the foam is prepared. These foams can be rigid, flexible, or semi-rigid foams, and can have a closed cell structure, an open cell structure or a mixture of open and closed cells. These foams are used in a variety of well-known applications, including but not limited to thermal insulation, cushioning, flotation, packaging, adhesives, void filling, crafts and decorative, and shock absorption.

It will be appreciated by those skilled in the art, especially in view of the disclosure contained herein, that the order and manner in which the blowing agent of the present invention is formed and/or added to the foamable composition does not generally affect the operability of the present invention. For example, in the case of extrudable foams, it is possible that the various components of the blowing agent, and even the components of the present composition, not be mixed in advance of introduction to the extrusion equipment, or even that the components are not added to the same location in the extrusion equipment. Thus, in certain embodiments it may be desired to introduce one or more components of the blowing agent at first location in the extruder, which is upstream of the place of addition of one or more other components of the blowing agent, with the expectation that the components will come together in the extruder and/or operate more effectively in this manner. Nevertheless, in certain embodiments, two or more components of the blowing agent are combined in advance and introduced together into the foamable composition, either directly or as part of premix which is then further added to other parts of the foamable composition.

One aspect of the invention is directed to a blowing agent composition comprising at least about 5% by weight of vinylidene fluoride (CH₂═CF₂) and from about 0.1 to about 60% by weight of at least one co-blowing agent. In one embodiment the blowing agent composition comprises from about 40 to about 99.9 percent by weight of vinylidene fluoride (CH₂═CF₂) and from about 0.1 to about 40 percent by weight of said at least one co-blowing agent. In another embodiment the blowing agent composition comprises from about 60 to about 90 percent by weight of vinylidene fluoride (CH₂═CF₂) and from about 10 to about 40 percent by weight of said at least one co-blowing agent. In one specific embodiment vinylidene fluoride (CH₂═CF₂) comprises at least about 15% by weight of the composition. In another specific embodiment vinylidene fluoride (CH₂═CF₂) comprises at least about 60% by weight of the composition. The co-blowing agent is preferably selected from the group consisting of a hydrocarbon, a hydrofluorocarbon, an ether, an alcohol, an aldehyde, a ketone, methyl formate, formic acid, water, trans-1,2-dichloroethylene, CO₂ and combinations of two or more thereof.

Another aspect of the invention is directed to a foamable composition comprising the blowing agent composition as disclosed above and at least one component capable of forming a thermoplastic foam or a thermoset foam.

Yet another aspect of the invention is directed to a closed cell foam formed from the foamable composition disclosed above.

A further aspect of the invention is directed to a foam premix composition comprising polyol and vinylidene fluoride (CH₂═CF₂).

Another aspect of the invention is directed to a method of forming a foam comprising adding to a foamable and/or foaming composition a blowing agent comprising vinylidene fluoride (CH₂═CF₂) under conditions effective to form a foamed cellular structure, wherein said foamable or foaming composition comprises a foam-forming substance selected from isocyanate, polyol and combinations of these.

Other uses of the present compositions include use as solvents for example as supercritical or high pressure solvents, deposition agents, extractants, cleaning agents, and the like. Those of skill in the art will be readily able to adapt the present compositions for use in such applications without undue experimentation.

### EXAMPLES

The invention is further illustrated in the following examples which are intended to be illustrative, but not limiting in any manner.

### Example 1

The coefficient of performance (COP) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the amount of cooling or heating it provides and provides some measure of the capability of a compressor to pump quantities of heat for a given volumetric flow rate of refrigerant. In other words, given a specific compressor, a refrigerant with a higher capacity will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988).

A refrigeration/air conditioning cycle system is provided where the condenser temperature is about −20° F. and the evaporator temperature is about −100° F. under nominally isentropic compression with a compressor inlet temperature of about 80° F. COP is determined for a composition consisting essentially of vinylidene fluoride (CH₂═CF₂), over a range of condenser and evaporator temperatures, and each is found to have workable values of COP, capacity and discharge temperature. Accordingly, vinylidene fluoride (CH₂═CF₂) has a workable energy efficiency and a compressor using a refrigerant compositions containing vinylidene fluoride (CH₂═CF₂) will produce workable discharge temperatures.

### Example 2

### Polyol Foam

This example illustrates the use of blowing agents in accordance with preferred embodiments of the present invention, namely the use of vinylidene fluoride (CH₂═CF₂) for the production of polyol foams in accordance with the present invention. The components of a polyol foam formulation are prepared in accordance with the following Table:

TABLE

| Polyol Component | PBW |
|---|---|
| Voranol 490 | 50 |
| Voranol 391 | 50 |
| Water | 0.5 |
| B-8462 (surfactant) | 2.0 |
| Polycat 8 | 0.3 |
| Polycat 41 | 3.0 |
| vinylidene fluoride | 35 |
| Total | 140.8 |
| Isocyanate | |
| M-20S | 123.8 Index 1.10 |

*Voranol 490 is a sucrose-based polyol and Voranol 391 is a toluene diamine-based polyol, and each are from Dow Chemical, B-8462 is a surfactant available from Degussa-Goldschmidt. Polycat catalysts are tertiary amine-based and are available from Air Products. Isocyanate M-20S is a product of Bayer LLC.

The foam is prepared by first mixing the ingredients thereof, but without the addition of blowing agent. Two Fisher-Porter tubes are each filled with about 52.6 grams of the polyol mixture (without blowing agent) and sealed and placed in a refrigerator to cool and form a slight vacuum. Using gas burets, about 17.4 grams of vinylidene fluoride (CH₂═CF₂) is added to each tube, and the tubes are then placed in an ultrasound bath in warm water and allowed to sit for 30 minutes. The isocyanate mixture, about 87.9 grams, is placed into a metal container and placed in a refrigerator and allowed to cool to about 50° F. The polyol tubes were then opened and weighed into a metal mixing container (about 100 grams of polyol blend are used). The isocyanate from the cooled metal container is then immediately poured into the polyol and mixed with an air mixer with double propellers at 3000 RPM's for 10 seconds. The blend immediately begins to froth with the agitation and is then poured into an 8×8×4 inch box and allowed to foam.

The foam is then allowed to cure for two days at room temperature. The foam is then cut to samples suitable for measuring physical properties and is found to have acceptable density and Kfactor.

### Example 3

### Polstyrene Foam

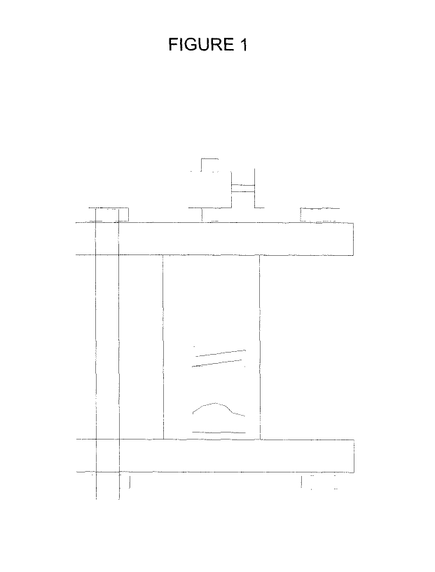

This example illustrates the use of blowing agent, namely the use of vinylidene fluoride (CH₂═CF₂) as a blowing agent for the production of polystyrene foam. A testing apparatus and protocol has been established as an aid to determining whether a specific blowing agent and polymer are capable of producing a foam and the quality of the foam. Ground polymer (Dow Polystyrene 685D) and blowing agent consisting essentially of vinylidene fluoride (CH₂═CF₂) are combined in a vessel. A sketch of the vessel is illustrated in FIG. 1. The vessel volume is 200 cm³ and it is made from two pipe flanges and a section of 2-inch diameter schedule 40 stainless steel pipe 4 inches long. The vessel is placed in an oven, with temperature set at from about 190° F. to about 285° F., preferably for polystyrene at 265° F., and remains there until temperature equilibrium is reached. The pressure in the vessel is then released, quickly producing a foamed polymer. The blowing agent plasticizes the polymer as it dissolves into it. The resulting density of the two foams thus produced using this method is determined and found to be acceptable.

### Example 4A

### Polstyrene Foam

This example demonstrates the performance of vinylidene fluoride (CH₂═CF₂) as a blowing agent for polystyrene foam formed in a twin screw type extruder. The apparatus employed in this example is a Leistritz twin screw extruder having the following characteristics:

30 mm co-rotating screws

L:D Ratio=40:1

The extruder is divided into 10 sections, each representing a L:D of 4:1. The polystyrene resin was introduced into the first section, the blowing agent was introduced into the sixth section, with the extrudate exiting the tenth section. The extruder operated primarily as a melt/mixing extruder. A subsequent cooling extruder is connected in tandem, for which the design characteristics were:

Leistritz twin screw extruder

40 mm co-rotating screws

L:D Ratio=40:1

Die: 5.0 mm circular

Polystyrene resin, namely Nova Chemical—general extrusion grade polystyrene, identified as Nova 1600, is feed to the extruder under the conditions indicated above. The resin has a recommended melt temperature of 375° F.-525° F. The pressure of the extruder at the die is about 1320 pounds per square inch (psi), and the temperature at the die is about 115° C.

A blowing agent consisting essentially of vinylidene fluoride (CH₂═CF₂) is added to the extruder at the location indicated above, with about 0.5% by weight of talc being included, on the basis of the total blowing agent, as a nucleating agent. Foam is produced using the blowing agent at concentrations of 10% by weight, 12% by weight, and 14% by weight, in accordance with the present invention. The density of the foam produced is in the range of about 0.1 grams per cubic centimeter to 0.07 grams per cubic centimeter, with a cell size of about 49 to about 68 microns. The foams, of approximately 30 millimeters diameter, are visually of very good quality, very fine cell size, with no visible or apparent blow holes or voids.

### Example 4B

### Polystyrene Foam

This procedure of Example 5C is repeated except that the foaming agent comprises about 50% by weight of vinylidene fluoride (CH₂═CF₂) and 50% by weight of HFC-245fa and nucleating agent in the concentration indicated in Example 5. Foamed polystyrene is prepared at blowing agent concentrations of approximately 10% and 12%. The density of the foam produced is about 0.09 grams per cubic centimeter, with a cell size of about 200 microns. The foams, of approximately 30 millimeters diameter, are visually of very good quality, fine cell structure, with no visible or apparent voids.

### Example 4C

### Polystyrene Foam

This procedure of Example 5 is repeated except that the foaming agent comprises about 80% vinylidene fluoride (CH₂═CF₂) and 20% by weight of HFC-245fa and nucleating agent in the concentration indicated in Example 5. Foamed polystyrene is prepared at blowing agent concentrations of approximately 10% and 12%. The density of the foam produced is about 0.08 grams per cubic centimeter, with a cell size of about 120 microns. The foams, of approximately 30 millimeters diameter, are visually of very good quality, fine cell structure, with no visible or apparent voids.

### Example 4D

### Polystyrene Foam

This procedure of Example 5 is repeated with vinylidene fluoride (CH₂═CF₂) provided alone and the nucleating agent is omitted. The foams' density was in the range of 0.1 grams per cubic centimeter, and the cell size diameter is about 400. The foams, of approximately 30 millimeters diameter, are visually of very good quality, fine cell structure, with no visible or apparent voids.

### Example 5

### Polyurethane Foam

This example demonstrates the performance of vinylidene fluoride (CH₂═CF₂), used in combination with hydrocarbon co-blowing agents, and in particular the utility of compositions comprising vinylidene fluoride (CH₂═CF₂) alone and with cyclopentane co-blowing agents to produce polyurethane foams having acceptable compressive strength performance.

A commercially available, refrigeration appliance-type polyurethane foam formulation (foam forming agent) is provided. The polyol blend consisted of commercial polyol(s), catalyst(s), and surfactant(s). This formulation is adapted for use in connection with a gaseous blowing agent. Standard commercial polyurethane processing equipment is used for the foam forming process. A gaseous blowing agent combination was formed comprising vinylidene fluoride (CH₂═CF₂) in a concentration of approximately 60 mole percent, and cyclopentane in a concentration of approximately 40 mole percent of the total blowing agent. This example illustrates acceptable physical property performance, including compressive strength and K-factor performance of combinations of vinylidene fluoride (CH₂═CF₂) in combination with cyclopentane co-blowing agent.

### Example 6

### Polyurethane Foam K-Factors

This example demonstrates the performance of blowing agents comprising vinylidene fluoride (CH₂═CF₂) in combination with each of the HFC co-blowing agents mentioned above in connection with the preparation of polyurethane foams. The same foam formulation, equipment and procedures used in Examples 5 and 6 are used, with the exception of the blowing agent. A blowing agent is prepared comprising vinylidene fluoride (CH₂═CF₂) in a concentration of approximately 80 weight percent of the total blowing agent, and each of the HFC co-blowing agents mentioned above in a concentration of approximately 20 weight percent of the total blowing agent. Foams are then formed using this blowing agent and the k-factors of the foam are measured and found to be acceptable.

### Example 7

### Polyurethane Foam K-Factors

A further experiment is performed using the same polyol formulation and isocyanate as in Examples 5 and 6. The foam is prepared by hand mix. The blowing agent consists of vinylidene fluoride (CH₂═CF₂) in about the same mole percentage of the foamable composition as the blowing agent in Examples 5 and 6. Acceptable foams are formed.

### Example 8

### Polyurethane Foam K-Factors

A further experiment is performed using the same polyol formulation and isocyanate as in Examples 5 and 6. The foam is prepared by hand mix. A series of blowing agent consisting vinylidene fluoride (CH₂═CF₂) and each of methanol, propanol, isopropanol, butanol, isobutanol and t-butanol in a 50:50 mole ratio, each combination being present in the blowing agent composition in about the same mole percentage of the foamable composition as the blowing agent in Examples 5 and 6. In each case an acceptable foam is formed.

### Example 9

### Polyurethane Foam K-Factors

A further experiment is performed using the same polyol formulation and isocyanate as in Examples 5 and 6. The foam is prepared by hand mix. A series of blowing agents consisting of vinylidene fluoride (CH₂═CF₂) and each of the following additional compounds: iso-pentane, normal-pentane and cyclo-pentane. Three blowing agents are formed in combination with each additional compound in CH₂═CF₂:additional compound mole ratios of 25:75, 50:50, and 75:25. Each blowing agent composition is present in about the same mole percentage of the foamable composition as the blowing agent in Examples 5 and 6. An acceptable foam is formed in each case.

### Example 10

### Polyurethane Foam K-Factors

A further experiment is performed using the same polyol formulation and isocyanate as in Examples 5 and 6. The foam is prepared by hand mix. A series of blowing agents consisting of vinylidene fluoride (CH₂═CF₂) and each of the following additional compounds: water and CO₂. Three blowing agents are formed in combination with each additional compound in CH₂═CF₂:additional compound mole ratios of 25:75, 50:50, and 75:25. Each blowing agent composition is present in about the same mole percentage of the foamable composition as the blowing agent in Examples 5 and 6. An acceptable foam is formed in each case.

### Example 11

### Polyurethane Foam K-Factors

A further experiment is performed using the same polyol formulation and isocyanate as in Examples 5 and 6. The foam is prepared by hand mix. A series of blowing agent consisting of vinylidene fluoride (CH₂═CF₂) and each of HFO-1234ye-trans(E) (having a boiling point of 15 C) and HFO-1234ye-cis(Z) (having a boiling point of 24 C), in combination with CH₂═CF₂ in a 50:50 mole ratio, each combination being present in the blowing agent composition in about the same mole percentage of the foamable composition as the blowing agent in Examples 5 and 6. An acceptable foam is formed in each case.

### Example 12

### Polyurethane Foam K-Factors

A further experiment is performed using the same polyol formulation and isocyanate as in Examples 5 and 6. The foam is prepared by hand mix. A blowing agent consisting of vinylidene fluoride (CH₂═CF₂) and trans-1,2 dichloroethylene, in an CH₂═CF₂:trans-1,2 dichloroethylene mole ratio of 75:25, with the blowing agent composition being in about the same mole percentage of the foamable composition as the blowing agent in Examples 5 and 6. An acceptable foam is formed.

### Example 13

### Polyurethane Foam K-Factors

A further experiment is performed using the same polyol formulation and isocyanate as in Example 9. The foam is prepared by hand mix. The blowing agent consisting of vinylidene fluoride (CH₂═CF₂) and methyl formate, in a 75:25 mole ratio, the combination being present in the blowing agent composition in about the same mole percentage of the foamable composition as the blowing agent in Examples 5 and 6. An acceptable foam is formed in each case.

### Example 14

### Aerosol

A sprayable aerosol was prepared by adding a composition consisting of vinylidene fluoride (CH₂=CF₂) to an aerosol can, sealing the can by crimping an aerosol valve in place and adding HFC-134a propellant to a concentration of about 14% by weight of the 134a and about 76% by weight of the vinylidene fluoride (CH₂═CF₂). Hydraulic fluid was applied to a metal coupon with a cotton swab and the coupon was weighed. The vinylidene fluoride (CH₂═CF₂)-containing aerosol was sprayed onto the metal substrate for 10 seconds. The coupon was allowed to dry and was reweighed. Approximately 60% by weight of the hydraulic fluid was removed.

It is apparent that many modifications and variations of this invention as hereinabove set forth may be made without departing from the spirit and scope thereof. The specific embodiments are given by way of example only and the invention is limited only by the terms of the appended claims.

What is claimed is:

1. A blowing agent composition comprising at least about 5% by weight of vinylidene fluoride (CH₂═CF₂) and from about 0.1 to about 60% by weight of at least one co-blowing agent.

2. The blowing agent composition of claim 1 comprising from about 40 to about 99.9 percent by weight of vinylidene fluoride (CH₂═CF₂) and from about 0.1 to about 40 percent by weight of said at least one co-blowing agent.

3. The blowing agent composition of claim 1 comprising from about 60 to about 90 percent by weight of vinylidene fluoride (CH₂═CF₂) and from about 10 to about 40 percent by weight of said at least one co-blowing agent.

4. The blowing agent composition of claim 1 wherein said vinylidene fluoride (CH₂═CF₂) comprises at least about 15% by weight of the composition.

5. The blowing agent composition of claim 1 wherein said vinylidene fluoride (CH₂═CF₂) comprises at least about 60% by weight of the composition.

6. The blowing agent composition of any one of claims 1 to 5 wherein the co-blowing agent is selected from the group consisting of a hydrocarbon, a hydrofluorocarbon, an ether, an alcohol, an aldehyde, a ketone, methyl formate, formic acid, water, trans-1,2-dichloroethylene, CO₂ and combinations of two or more thereof.

7. A foamable composition comprising the blowing agent composition of any one of claims 1 to 6 and at least one component capable of forming a thermoplastic foam or a thermoset foam.

8. A closed cell foam formed from the foamable composition of claim 7.

9. A foam premix composition comprising polyol and vinylidene fluoride (CH₂═CF₂).

10. A method of forming a foam comprising adding to a foamable and/or foaming composition a blowing agent comprising vinylidene fluoride (CH₂═CF₂) under conditions effective to form a foamed cellular structure, wherein said foamable or foaming composition comprises a foam-forming substance selected from isocyanate, polyol and combinations of these.
